(19) United States
(12) Patent Application Publication
(10) Pub. No.: US 2006/0022979 A1
(43) Pub. Date: Feb. 2, 2006

(54) Method and apparatus for presenting information with varying levels of detail

(76) Inventors: Jonathan Sevy, Easton, PA (US); Gerald S. Williams, Macungie, PA (US)

Correspondence Address: Ryan, Mason & Lewis, LLP, Suite 205, 1300 Post Road, Fairfield, CT, 06824, US

(21) Appl. No.: 10/900,445

(22) Filed: Jul. 27, 2004

(51) Int. Cl. G06T 17/00

(52) U.S. Cl. 345/428

(57) ABSTRACT

Methods and apparatus are disclosed for presenting information with varying levels of detail based on one or more regions of interest. A virtual viewport of the information to be displayed is mapped onto a three-dimensional surface; and the mapped information is projected in one dimension onto a display. The plurality of levels of detail include, for example, an expansion zone associated with a region of interest and a compression zone for portions of the information that are removed from a region of interest. The plurality of levels of detail are based on a shape of the three-dimensional surface. In one implementation, the three-dimensional surface is a three-dimensional cylindrical surface. The three-dimensional surface is reshaped to vary the degree of compression by varying a slope of the three-dimensional surface in the z-dimension.

### FIELD OF THE INVENTION

The present invention relates generally to techniques for presenting information and, more particularly, to techniques for presenting information with multiple levels of detail.

### BACKGROUND OF THE INVENTION

It is often desirable to present a portion of information with a greater level of detail than the rest of the information. For example, when editing a computer program, a programmer would typically like to have a greater focus on the lines of code currently being edited, while also maintaining a larger view of lines that are a bit further away. Similarly, when working on a Gantt diagram or a similar project-management document, a user would typically like to have a greater focus in the horizontal direction on the current region of interest, while also maintaining a larger view of the additional information that is outside of the region of interest. Further, a user may wish to display multiple regions in detail, such as the group of lines actively being edited, as well as the lines being pointed to by the mouse cursor. Generally, the level of detail should be related to the distance of the information from the region(s) of interest. For example, portions of the document that are further from a region of interest should be displayed with a lower level of detail, while portions of the document that are within the region of interest should be displayed with a higher level of detail.

A number of techniques have been proposed or suggested for presenting information with varying levels of detail. One technique presents multiple views of the document, either at the same level of detail or with multiple levels of detail. For example, a document map might show the entire document with a low level of detail and highlight the area being edited in the main window, or a window may be split to show two different regions of the same document. Multiple views, however, require the user to divert his or her attention between the various views, and take up more space on a screen.

Another technique applies a “magnifying glass” to the region of interest, displaying the region of interest at a higher level of magnification than the normal view. The magnifying glass approach obscures regions immediately adjacent to the region of interest by either covering them with part of the magnified portion or by “de-magnifying” them and showing them at a smaller size than normal. Thus, immediately adjacent regions become de-emphasized and more difficult to view than regions farther away. Yet another technique creates a bubble of magnification when the mouse cursor points to a region of interest. The magnification bubble, however, causes the overall displayed information to expand and portions of the image may drop off the image at the edges.

A need therefore exists for improved techniques for presenting information with varying levels of detail. A further need exists for a method and system for presenting information with varying levels of detail based on one or more regions of interest. Yet another need exists for a method and system for presenting information with varying levels of detail that allow more information to be presented at one time than the above-described traditional methods, while presenting a natural view of the information that is easy to follow.

### SUMMARY OF THE INVENTION

Generally, methods and apparatus are provided for presenting information with varying levels of detail based on one or more regions of interest. A virtual viewport of the information to be displayed is mapped onto a three-dimensional surface; and the mapped information is projected in one dimension onto a display. The plurality of levels of detail include, for example, an expansion zone associated with a region of interest and a compression zone for portions of the information that are removed from a region of interest. The plurality of levels of detail are based on a shape of the three-dimensional surface. In one implementation, the three-dimensional surface is a three-dimensional cylindrical surface.

The shape of the three-dimensional surface is recomputed if the information contains a new focus. In addition, the three-dimensional surface is reshaped to vary the degree of compression by varying a slope of the three-dimensional surface in the z-dimension.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional display for presenting information;

FIG. 2 illustrates a display for presenting information in accordance with the present invention;

FIG. 3 illustrates a three-dimensional cylindrical surface that is used to project information onto the display of FIG. 2 in accordance with one embodiment of the invention;

FIG. 4 is a compression diagram that views the cylindrical surface of FIG. 3 in the plane of the director curve;

FIG. 5 is a compression diagram in accordance with an alternate embodiment of the present invention that presents information with multiple levels of detail;

FIG. 6 is a compression diagram for vertically compressed images;

FIG. 7 is a flow chart describing an exemplary implementation of multi-foveal display process incorporating features of the present invention; and

FIG. 8 is a schematic block diagram of an exemplary computing system incorporating features of the present invention

### DETAILED DESCRIPTION

The present invention provides a method and system for presenting information with varying levels of detail based on one or more regions of interest. Unlike conventional magnifying techniques, which focus on magnifying an area of interest, the present invention displays information outside of the region(s) of interest with a lower level of detail. Thus, the present invention makes regions adjacent to the region of interest easier to view than more remote regions without causing information to be lost (it is merely displayed at a lower level of detail).

As discussed more fully below, the present invention maps a virtual viewport of the information onto a three-dimensional surface and projects the mapped information in the Z-dimension onto a display. In this manner, data is displayed contiguously at varying levels of detail based on the shape of the three-dimensional surface. In one exemplary implementation, a virtual viewport of the information is mapped onto a three-dimensional cylindrical surface and the mapped information is projected onto a display. The present invention thus displays information of interest in a larger size and visually compresses other information. The change in compression factors can be done in a single step or in a series of steps. With sufficient steps, a smooth tapered effect can make it appear as if the highlighted region is being viewed through a lens.

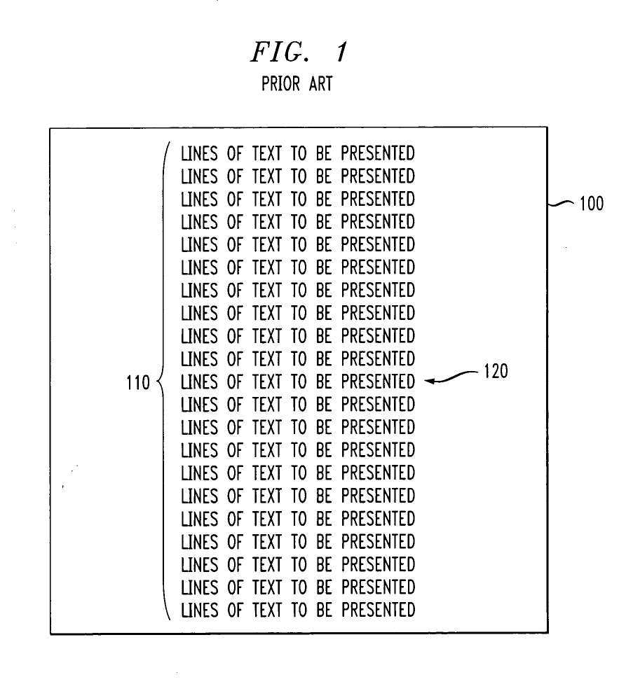

FIG. 1 illustrates a conventional display 100 for presenting information. As shown in FIG. 1, the exemplary display 100 presents a number of exemplary lines of text 110. The user may be editing one particular line of text 120. The information is presented on display 100 with the same level of detail.

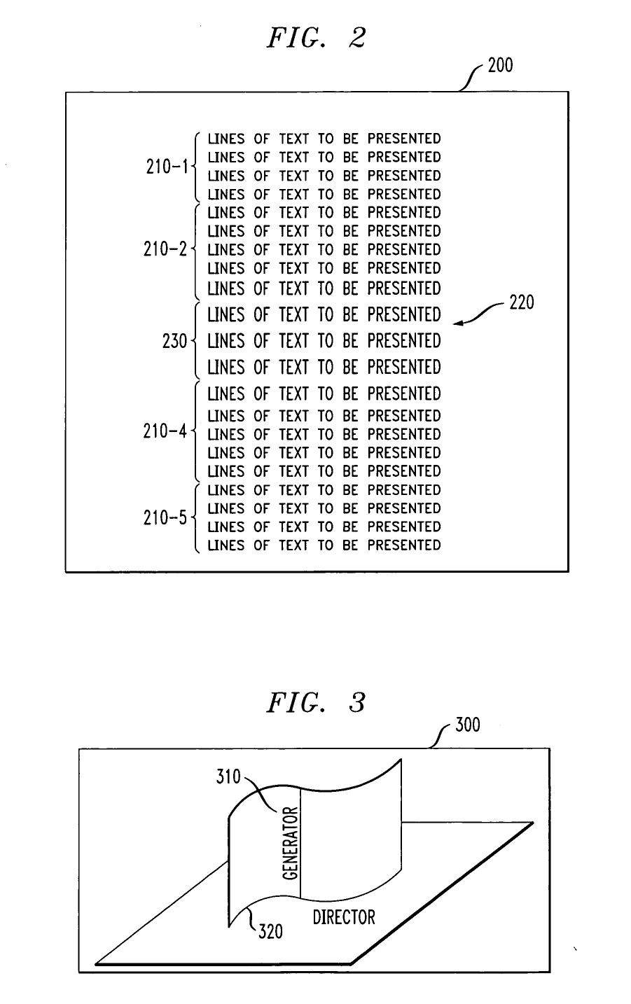

FIG. 2 illustrates a display 200 for presenting information in accordance with the present invention. As shown in FIG. 2, the exemplary display 200 presents a number of exemplary lines of text 210. The user may be editing one particular area of text 220, referred to herein as a region of interest. According to the present invention, the information is presented on display 200 with varying levels of detail.

In particular, as shown in FIG. 2, the information presented on the display 200 is grouped into regions, based on a distance from one or more regions of interest 230. In the exemplary embodiment shown in FIG. 2, a region of interest 230 is defined around the region of display 220 currently being edited by the user.

The region of interest 230, referred to as an expansion zone, is presented with a first, maximum level of detail. In the case of textual information, for example, the text can be presented with a given text size. In addition, in order to ensure that some of the information 110 in the normal view does not roll off the edge of the display 100 when the region of interest 230 is maximized, one or more additional regions are compressed, referred to as compression zones. As shown in FIG. 2, two regions 210-1 and 210-5 of the display 200 that are furthest from the region of interest 230 are presented in a compressed form with a minimum level of detail. In addition, two intermediate regions 210-2 and 210-4 that are adjacent to the region of interest 230 are presented with an intermediate level of detail, for example, using curve fitting techniques that transition between the level of detail of the region of interest and the compressed form.

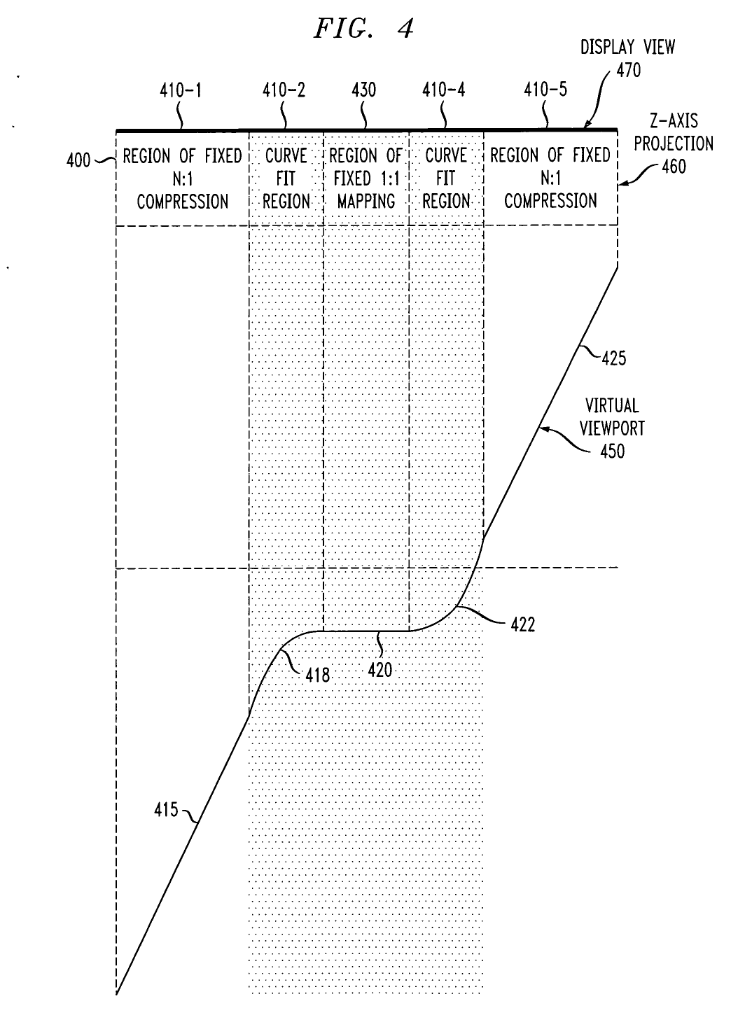

As previously indicated, the present invention presents information on a display 200 with varying levels of detail. FIG. 3 illustrates a three-dimensional cylindrical surface 300 that is used to project the information onto the display 200 to achieve the desired levels of detail. As used herein, a cylindrical surface 300 is a surface generated by moving a straight line 310, often referred to as a generator, parallel to itself along a plane curve 320, often referred to as a director, where the generator 310 is typically perpendicular to the plane of the director curve 320. See, for example, M. E. Mortenson, Geometric Modeling, John Wiley & Sons, Inc. (July, 1985). The three-dimensional cylindrical surfaces 300 allow the expansion and compression to occur in only one dimension. It is noted that alternative embodiments could employ any three-dimensional shape (or another mathematically equivalent model) where the slope in the z-dimension can be varied to alter the degree of compression in the projected image, as would be apparent to a person of ordinary skill in the art.

FIG. 4 is a compression diagram 400 that views the cylindrical surface 300 of FIG. 3 in the plane of the director curve 320. FIG. 4 illustrates the various compression and expansion zones of the present invention. As shown in FIG. 4, a virtual viewport 450 (representing the entire curve) is projected along a z-axis 460 onto the display 470. In an exemplary implementation, the compression diagram 400 provides two compression zones 410-1 and 410-5, corresponding to the regions 210-1, 210-5 that are furthest from the region of interest 230, two intermediate zones 410-2, 410-4, that are adjacent to the region of interest 230 are presented with an intermediate level of detail, and one or more expansion zones 430 corresponding to the region of interest 230.

As shown in FIG. 4, the cylindrical surface 300 of FIG. 3 provides for regions 410-1 and 410-5, 430 of fixed compression ratios that correspond to planar areas of the cylindrical surface 300 (and straight lines 415, 420, 425 in the compression diagram 400). These regions 415, 420, 425 may be connected by curved regions 418, 422, that may be mapped to planar regions using standard curve-fitting techniques. The entire diagram 400 represents the image that would be produced on the display 200, where the slope of the line 415, 418, 420, 422, 425 corresponds to the degree of compression (with horizontal indicating the most expanded).

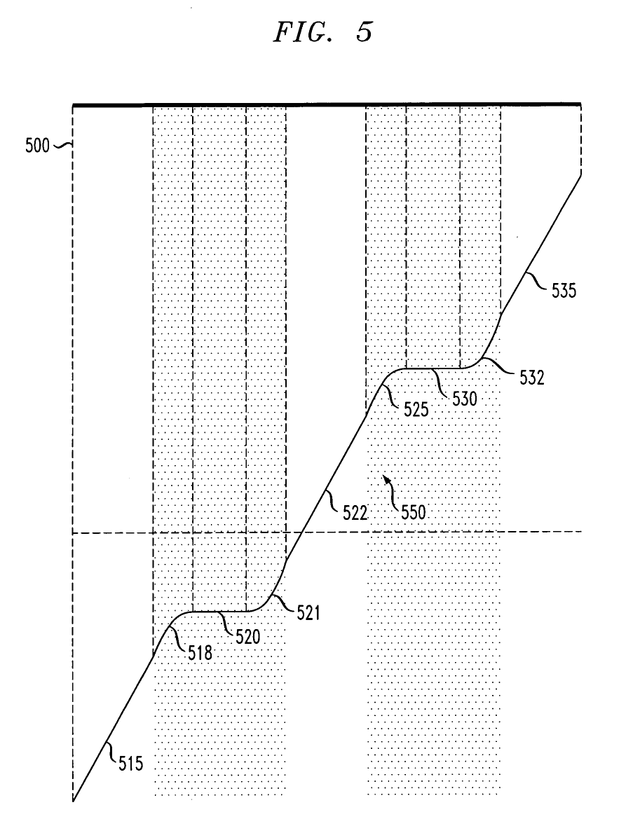

This effect may be duplicated multiple times on a display, as shown in FIG. 5, to provide additional levels of detail. FIG. 5 is a compression diagram 500 in accordance with an alternate embodiment of the present invention that presents information with multiple levels of detail. As shown in FIG. 5, the cylindrical surface provides for regions of fixed compression ratios that correspond to planar areas of the cylindrical surface 300 (and straight lines 515, 520, 522, 530, 540 in the compression diagram 500). These regions 515, 520, 522, 530, 540 may be connected by curved regions 518, 521, 525, 532, that may be mapped to planar regions using standard curve-fitting techniques, such as a sum of small lines. The diagram 500 represents the image that would be produced on the display 200, where the slope of the line515, 520, 522, 530, 540 corresponds to the degree of compression (with horizontal indicating the most expanded).

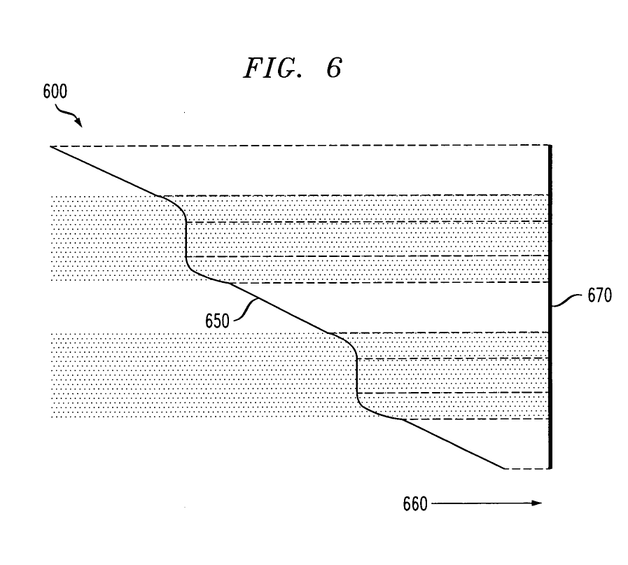

FIG. 6 is a compression diagram 600 for vertically compressed images. FIG. 6 illustrates the various compression and expansion zones of the present invention. As shown in FIG. 6, a virtual viewport 650 is projected at along a z-axis 660 onto the display 670. Generally, the compression diagram 600 for vertically compressed images rotates the horizontal diagram 400 of FIG. 4 by 90 degrees.

Rendering Image to Display

Regions 415, 420, 425 corresponding to planar areas are compressed through well-known means such as half-toning (when the type of the information is well-defined such as light text on a dark background or vice-versa, other mechanisms can be used to reduce the loss of information content through this compression). Regions 418, 422 corresponding to curved areas are first mapped onto planar regions through curve-fitting, in a known manner, which are in turn compressed onto the display.

Every point on the display 200 corresponds to a point on the cylindrical surface 300, which may be identified through projection. Thus, it is possible to support dynamic effects such as an expanding region which follows the mouse cursor when it is moved and disappears after it is stationary for some time. (Some hysteresis may be required due to the discrete mathematical rounding inherent in the nature of the system.)

The virtual viewport is rendered like a display view on a traditional system, which is then projected onto the actual display area. Thus, the final system would function exactly like a non-enhanced system, except that various portions of the display area would be expanded or compressed relative to each other.

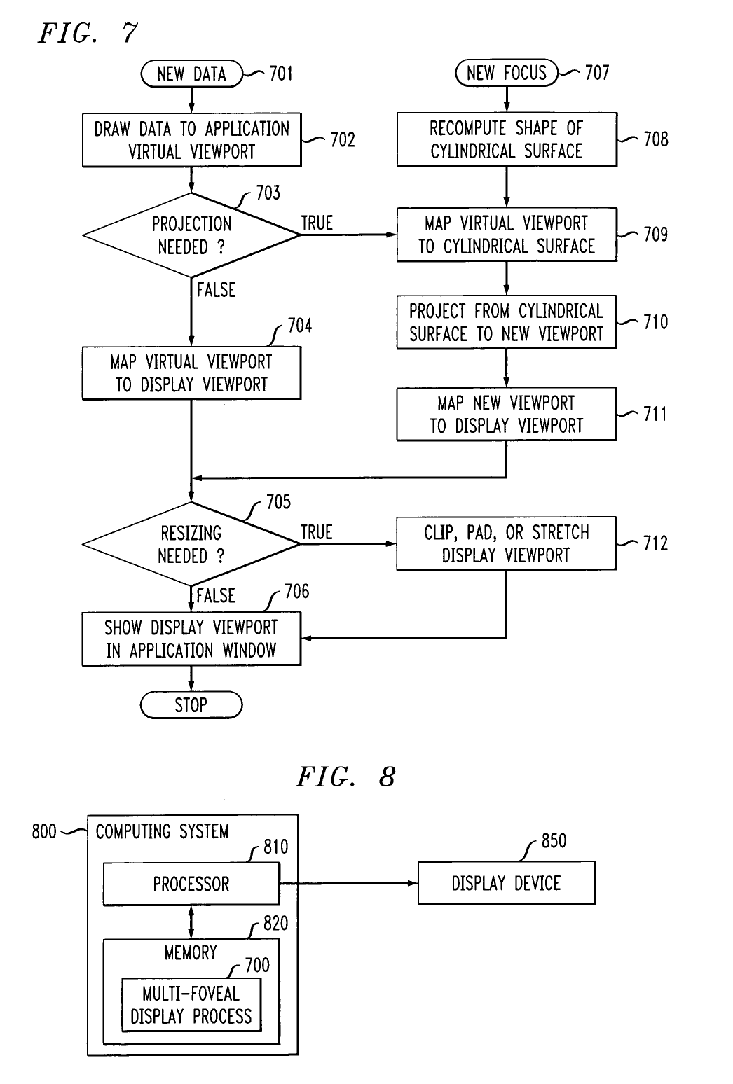

FIG. 7 is a flow chart describing an exemplary implementation of multi-foveal display process 700 incorporating features of the present invention. Generally, the multi-foveal display process 700 presents information on a display with multiple levels of detail. As shown in FIG. 7, the multi-foveal display process 700 is initiated during step 701 when the application has new data to be displayed. The data is drawn during step 702 at full resolution to a virtual two-dimensional viewport 450 containing all data to be displayed.

A test is performed during step 703 to determine if projection is needed. Projection is needed if the multi-foveal data display is enabled and the virtual viewport 450 is larger than the display area in either dimension. If projection is needed, program control proceeds to step 709, discussed below.

The virtual viewport 450 is mapped directly to the display viewport 470 during step 704. A test is performed during step 705 to determine if resizing is needed. Resizing is needed if the display viewport is not exactly the same shape as the display area of the application window. If resizing is needed, control proceeds to step 712, discussed below.

The display viewport is presented in the display area of the application window during step 706.

If one or more regions of interest were moved, resized, added, or deleted, program control is initiated at step 707. The shape of the cylindrical surface is recomputed during step 708 such that its surface area is the same as the virtual viewport and its projection to a plane perpendicular to the Z axis fits in the display area of the application window. The virtual viewport is mapped to the cylindrical surface 300 during step 709.

The cylindrical surface 300 is projected onto a new viewport that is on a plane perpendicular to its Z axis during step 710. The new viewport is mapped to the display viewport during step 711 and the display viewport it clipped, padded, and/or stretched as needed during step 712 to fit the display area of the application window.

FIG. 8 is a schematic block diagram of an exemplary computing system 800 incorporating features of the present invention. The computing system 800 may be any computing device, such as a personal computer, work station or server. As shown in FIG. 8, the exemplary computing system 800 includes a processor 810 and a memory 820, in addition to other conventional elements (not shown). The processor 810 operates in conjunction with the memory 820 to execute one or more software programs. Such programs may be stored in memory 820 or another storage device accessible to the computing system 800 and executed by the processor 810 in a conventional manner.

For example, the memory 820 may store the multi-foveal display process 700, discussed further below in conjunction with FIG. 7. Generally, the multi-foveal display process 700 presents information on a display device 850 with multiple levels of detail.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for displaying information, comprising:
mapping a virtual viewport of said information onto a three-dimensional surface; and
projecting said mapped information in one dimension onto a display.

2. The method of claim 1, wherein said information is displayed with a plurality of levels of detail that includes an expansion zone associated with a region of interest.

3. The method of claim 1, wherein said information is displayed with a plurality of levels of detail that includes a compression zone for portions of said information that are removed from a region of interest.

4. The method of claim 1, wherein said information is displayed contiguously with a plurality of levels of detail.

5. The method of claim 4, wherein said information is displayed with a plurality of levels of detail that are based on a shape of said three-dimensional surface.

6. The method of claim 1, wherein said three-dimensional surface is a three-dimensional cylindrical surface.

7. The method of claim 1, further comprising the step of drawing said information at a full resolution to a virtual two-dimensional viewport containing all of said information to be displayed.

8. The method of claim 1, further comprising the step of projecting said information if said virtual viewport is larger than the display area in either dimension.

9. The method of claim 1, further comprising the step of resizing said information if a display viewport is not the same shape as the display area of the application window.

10. The method of claim 1, further comprising the step of recomputing a shape of said three-dimensional surface if said information contains a new focus.

11. The method of claim 10, wherein a surface area of said recomputed three-dimensional surface is the same as the virtual viewport and its projection to a plane perpendicular to the Z axis fits in the display area of the application window.

12. The method of claim 10, further comprising the step of reshaping said three-dimensional surface to vary a degree of compression by varying a slope of said three-dimensional surface in a z-dimension.

13. An apparatus for displaying information, the apparatus comprising:
a display;
a memory; and
at least one processor, coupled to the memory, operative to:
map a virtual viewport of said information onto a three-dimensional surface; and
project said mapped information in one dimension onto said display.

14. The apparatus of claim 13, wherein said information is displayed with a plurality of levels of detail that includes an expansion zone associated with a region of interest.

15. The apparatus of claim 13, wherein said information is displayed with a plurality of levels of detail that includes a compression zone for portions of said information that are removed from a region of interest.

16. The apparatus of claim 13, wherein said information is displayed contiguously with a plurality of levels of detail.

17. The apparatus of claim 16, wherein said information is displayed with a plurality of levels of detail that are based on a shape of said three-dimensional surface.

18. The apparatus of claim 13, wherein said three-dimensional surface is a three-dimensional cylindrical surface.

19. The apparatus of claim 13, wherein said processor is further configured to recomputed a shape of said three-dimensional surface if said information contains a new focus.

20. The apparatus of claim 19, wherein a surface area of said recomputed three-dimensional surface is the same as the virtual viewport and its projection to a plane perpendicular to the Z axis fits in the display area of the application window.

21. The apparatus of claim 19, wherein said processor is further configured to reshape said three-dimensional surface to vary a degree of compression by varying a slope of said three-dimensional surface in a z-dimension.

22. An article of manufacture displaying information with a plurality of levels of detail, comprising a machine readable medium containing one or more programs which when executed implement the steps of:
mapping a virtual viewport of said information onto a three-dimensional surface; and
projecting said mapped information in one dimension onto a display.
